(19) United States
(12) Patent Application Publication
(10) Pub. No.: US 2007/0223431 A1
(43) Pub. Date: Sep. 27, 2007

(54) WLAN fast join

(75) Inventor: Mikko Jaakkola, Lempaala (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/388,914

(22) Filed: Mar. 24, 2006

(51) Int. Cl. H04Q 7/24

(52) U.S. Cl. 370/338

(57) ABSTRACT

A new and unique method and apparatus to provide a mobile node, point, terminal or device with a technique to initiate a join operation with timing information received from a previous beacon and WLAN chipset's internal reference timestamp so that the WLAN chipset can synchronize itself with an access point network without needing to wait for a subsequent beacon as defined in the 802.11 standard specs. So, in other words, the essential aspect of the present invention is that the WLAN modem needs to get necessary timestamp (a time synchronization function (TSF)-correction)) information for performing the join-operation. The mobile node, point, terminal or device has its own TSF-counter and to join with the access point the TSF-counter needs to be synchronized with the access points TSF-counter. This update is performed in the WLAN modem using a communication that has been previously received from the access point (latest beacon, probe, etc.). With this information already available, there is no need for the WLAN modem to wait for the next beacon to perform the join operation.

### BACKGROUND OF THE INVENTION

1. Field of Invention

The present invention relates to wireless communication in wireless local area network (WLAN) environment, including but not limited to that set forth in IEEE 802.11; and more particularly, the present invention provides a method and system for enhancing WLAN terminal operation in connection with joining/synchronizing with an access point network.

2. Description of Related Art

FIG. 1 shows, by way of example, typical parts of an IEEE 802.11 WLAN system, which is known in the art and provides for communications between communications equipment such as mobile and secondary devices including personal digital assistants (PDAs), laptops and printers, etc. The WLAN system may be connected to a wired LAN system that allows wireless devices to access information and files on a file server or other suitable device or connecting to the Internet.

The devices can communicate directly with each other in the absence of a base station in a so-called “ad-hoc” network, or they can communicate through a base station, called an access point (AP) in IEEE 802.11 terminology, with distributed services through the AP using local distributed services (DS) or wide area extended services, as shown. In a WLAN system, end user access devices are known as stations (STAs), which are transceivers (transmitters/receivers) that convert radio signals into digital signals that can be routed to and from communications device and connect the communications equipment to access points (APs) that receive and distribute data packets to other devices and/or networks. The STAs may take various forms ranging from wireless network interface card (NIC) adapters coupled to devices to integrated radio modules that are part of the devices, as well as an external adapter (USB), a PCMCIA card or a USB Dongle (self contained), which are all known in the art.

FIGS. 2a and 2b show diagrams of the Universal Mobile Telecommunications System (UMTS) packet network architecture, which is also known in the art. In FIG. 2a, the UMTS packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) Iu interface. FIG. 2b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 2a. A given UE may be in radio contact with multiple Node Bs even if one or more of the Node Bs are connected to different RNCs. For instance, a UE1 in FIG. 2b may be in radio contact with Node B2 of RNS1 and Node B3 of RNS2 where Node B2 and Node B3 are neighboring Node Bs. The RNCs of different RNSs may be connected by an Iur interface which allows mobile UEs to stay in contact with both RNCs while traversing from a cell belonging to a Node B of one RNC to a cell belonging to a Node B of another RNC. The convergence of the IEEE 802.11 WLAN system in FIG. 1 and the (UMTS) packet network architecture in FIGS. 2a and 2b has resulted in STAs taking the form of UEs, such as mobile phones or mobile terminals. The interworking of the WLAN (IEEE 802.11) shown in FIG. 1 with such other technologies (e.g. 3GPP, 3GPP2 or 802.16) such as that shown in FIGS. 2a and 2b is being defined at present in protocol specifications for 3GPP and 3GPP2.

Before a WLAN node, point, terminal or device can communicate with another node, point, terminal or device in a WLAN like that shown in FIG. 1, it must first join the WLAN using a join operation, for example, such as that set forth in the IEEE 802.11 standards, which are all incorporated by reference herein. In the IEEE 802.11 standard, when a WLAN device is making a join, it needs to wait for a next beacon (or pilot frame defined in 802.11 k) to complete the join operation using information contained in the next beacon signal. This can take up to 100 ms (or in pilot frame case up to 10 ms).

In addition, United States patent application publication no. US 2005/0128988 discloses an enhanced passive scanning method for a WLAN based on a join operation that includes using information contained in the beacon signal as well as other information received from an access point in the WLAN. In particular, the enhanced passive scanning method includes steps of transmitting at least one of a beacon signal or a gratuitous probe response in a WLAN channel by an access point. The gratuitous probe response is a supplemental beacon signal that is transmitted at intervals between the occurrence of regular beacon signals, but contains only essential information to allow mobile station manage roaming and timing. Although this disclosure is not related to device internal synchronization, like that disclosed in WO 2004/114563 discussed below, it does describe a technique in which mobile terminals are provided with information relating to the timing of the network for the mobile terminals to have specific timing information relating to a next coming beacon so that the device can more effectively join to the network after receiving a next beacon. The subject matter of United States patent application publication no. US 2005/0128988 is hereby incorporated by reference in its entirety.

Moreover, there are known techniques relating to how to synchronize firewire and WLAN databuses for enabling communication over a physical interface. For example, WO 2004/114563, entitled “A method for clock synchronization of wireless 1394 buses for nodes connected via IEEE 802.11 LAN,” discloses a method and apparatus for providing clock synchronization of 1394 buses having wireless devices utilizing 802.11 communication with computers attached to one or more 1394 buses, includes the steps of (a) synchronizing an internal time base of a wireless master device attached to a first bus by receiving a Software Beacon Alert that indicates a time of a subsequent transmission, applying the Software Beacon Alert to a first phase-lock loop circuit associated with the master device to create a filtered Software Beacon Alert. The first phase-lock loop circuit is unsymmetrical about zero error. A timing message is transmitted from the master device to a second phase-lock loop circuit associated with at least one slave device. The timing message must be sent to the at least one slave device before the master device receives a subsequent Software Beacon Alert message, so that the wireless master device and the at least one slave device are synchronized, even though they are on different buses. This disclosures allows 1394 devices having wireless means to communicate over an 802.11 WLAN network, so that communications can be synchronized between the master and slave device across 1394 serial buses, and is hereby incorporated by reference in its entirety.

In view of the aforementioned, there is a need in the art for a method, system or technique in which nodes, points, terminals or devices have a way to perform joining to the AP network even before the next beacon is received.

### SUMMARY OF THE INVENTION

The basic idea a method and apparatus to provide a mobile node, point, terminal or device with a technique to initiate a join operation with timing information received from a previous beacon and WLAN chipset's internal reference timestamp so that the WLAN chipset can synchronize itself with an access point network without needing to wait for a subsequent beacon as defined in the 802.11 standard specification.

The essential or key aspect of the present invention is that the WLAN modem needs to get necessary timestamp (a time synchronization function (TSF)-correction)) information for performing the join-operation. The mobile node, point, terminal or device has its own TSF-counter and to join with the access point the TSF-counter is synchronized with the access points TSF-counter. This update is performed in the WLAN modem using the communication that has been previously received from the access point (latest beacon, probe, etc.). With this information already available, there is no need for the WLAN modem to wait for the next beacon to perform the join operation.

By way of example, the present invention may be implemented using at least two alternative embodiments, as follows:

1) The join operation may be performed before receiving the next beacon that enables fast joining to the network. This embodiment is against the current 80.11 Specs., but is clearly the preferred embodiment of the present invention as the needed time to perform join is optimized. Further, a WLAN access point or any other associated device is not capable of detecting whether this newly joined device has operated according to the requirements of the current WLAN Specs.

2) The join operation initially performed before the next beacon but the actual join-operation is performed immediately after receiving the next beacon to comply with the standard Specs. The benefits for this embodiment are substantially small as the device needs to still wait for the subsequent beacon before performing the join operation but this makes association to the network somewhat faster as the join operation is basically performed beforehand.

In operation, the method and apparatus according to the present invention use a previously received frame to perform the join operation by using a special mechanism that is defined in the implementation section. For example, when a terminal is doing a scan and receiving the frames, it receives both, the official timestamp from the 802.11 frame as well as a chipset's reference timestamp for the frame. Then using both time-stamps, the WLAN chipset can synchronise itself with the WLAN network without waiting for any new beacons.

The present invention may also take the form of a node, point, terminal or device for joining such a wireless local area network (WLAN) or other suitable network, as well as a network node, point, terminal or device for joining with a node, point, terminal or device in such a wireless local area network (WLAN) or other suitable network.

The scope of the invention also includes a WLAN chipset for a node, point, terminal or device in a wireless local area network (WLAN) or other suitable network, as well as a computer program product with a program code, which program code is stored on a machine readable carrier, for carrying out the steps of the method according to the present invention. The method may also feature implementing the step of the method via a computer program running in a processor, controller or other suitable module in one or more network nodes, points, terminals or elements in the wireless LAN network.

Finally, the present invention also provides a method for initiating a join operation with a wireless local area network (WLAN) in a wireless communications device, featuring elements for, or steps of, receiving timing information regarding the WLAN from a periodic non-payload network transmission; obtaining timing information regarding the wireless communications device's internal clock; and synchronizing the wireless communications device's internal clock with the WLAN reference timing before receiving subsequent non-payload transmission; as well as a wireless communications device, featuring a wireless communications interface for receiving timing information regarding a wireless local area communications network (WLAN) from a periodic non-payload network transmission; a timer module managing an internal clock: and a controller coupled with the wireless communications interface and the timer module configured to synchronize the internal clock with the WLAN reference timing before receiving subsequent non-payload transmission. In each case, the periodic non-payload network transmission may include a WLAN beacon message.

The node, point, terminal or device may include an access point or a station (STA), while the network node, point, terminal or device may include an access point in the wireless local area network (WLAN) or other suitable network.

One advantage of the present invention is that it allows a system to do an instant join in zero time thus improving the worst case up to 100 ms, which is particularly useful in situations where faster joining is preferred (e.g. when roaming between WLAN networks during, for example, a VoIP call.

### BRIEF DESCRIPTION OF THE DRAWING

The drawing includes the following Figures, which are not necessarily drawn to scale:

FIG. 1 shows typical parts of an IEEE 802.11 WLAN system, which is known in the art.

FIGS. 2a and 2b show diagrams of the Universal Mobile Telecommunications System (UMTS) packet network architecture, which is also known in the art.

FIG. 3 shows an access point (AP) according to an embodiment of the present invention.

FIG. 4 shows a station (STA) according to an embodiment of the present invention.

FIG. 5 shows an exemplary block diagram of the module 22 in FIG. 4 in the form of a WLAN chipset according to an embodiment of the present invention.

FIG. 6 shows an exemplary flowchart of basic steps of a method according to an embodiment of the present invention.

### BEST MODE OF THE INVENTION

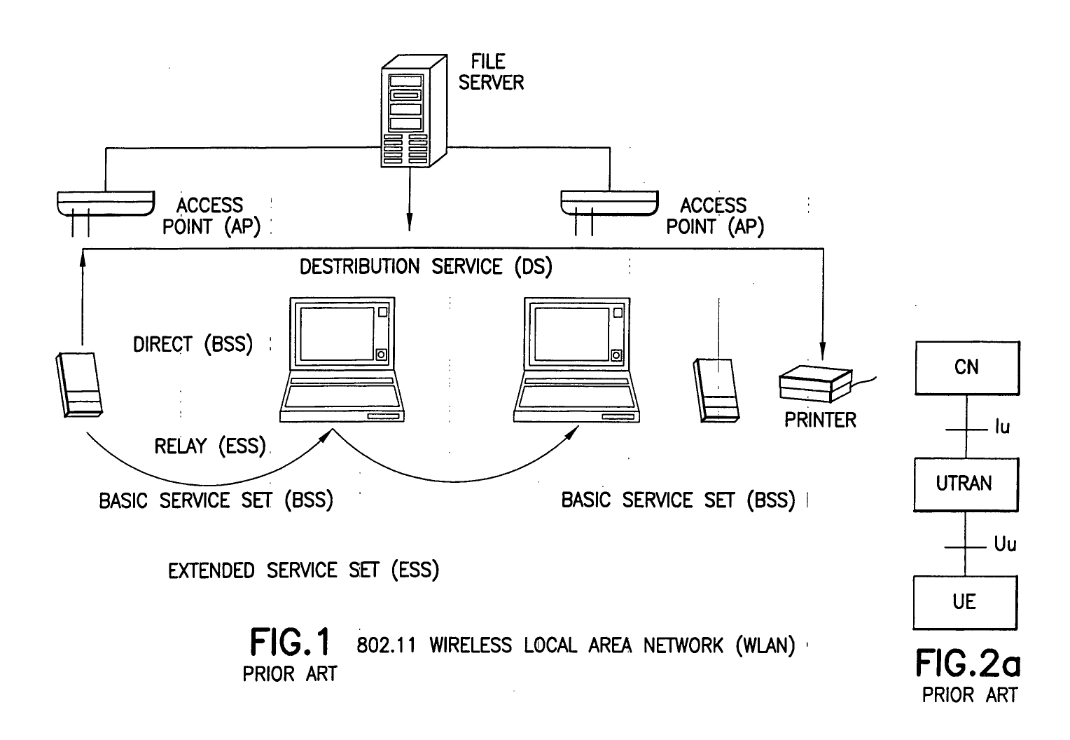

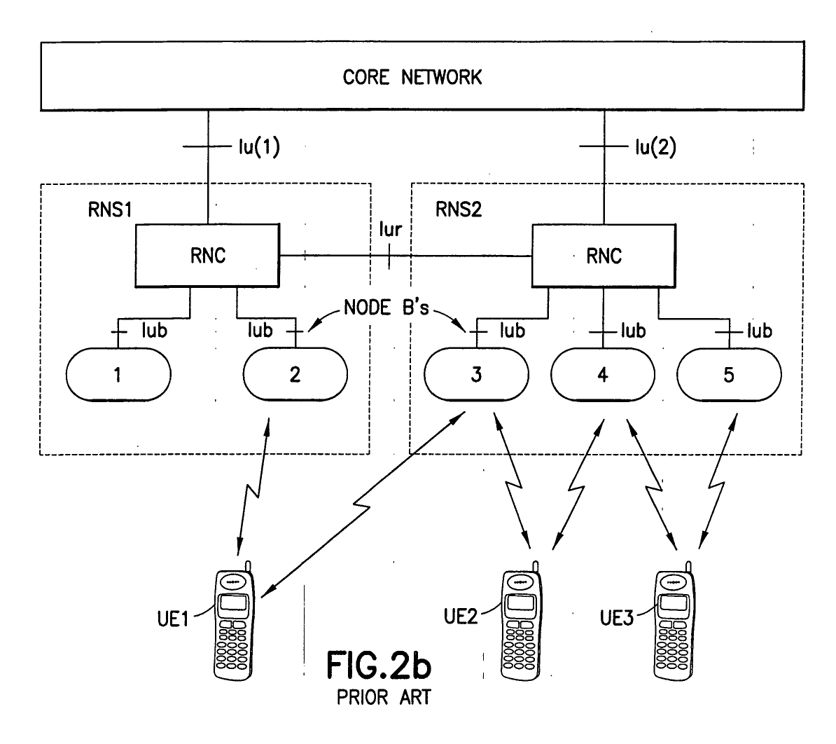

The present invention provides a new and unique method and apparatus for a node, point, terminal or device to join a wireless local area network (WLAN), or other suitable network, such as that shown in FIGS. 1-2, where a join operation is initiated based on timing information received from a previous beacon and a WLAN chipset's internal reference timestamp so that a WLAN chipset can synchronize itself with a network node, point, terminal or device of the WLAN or other suitable network without needing to wait for a subsequent beacon.

The basic idea is to use a previously received frame to perform the join operation by using a special mechanism that is defined in the implementation section. For example, when a terminal is doing a scan and receiving the frames, it receives both, the official timestamp from the 802.11 frame as well as a chipset's reference timestamp for the frame. Then using both time-stamps, the WLAN chipset can synchronise itself with the WLAN network without waiting for any new beacons.

The join operation includes synchronizing a time synchronization function (TSF) counter of the node, point, terminal or device with a corresponding time synchronization function (TSF) counter of the network node, point, terminal or device. In the WLAN, the node, point, terminal or device may take the form of a station (STA) or other node, point, terminal or device having similar functionality, while the network node, point, terminal or device may take the form of an access point (AP) or other network node, point, terminal or device having similar functionality.

### The Implementation

According to the present invention, the WLAN Fast-join technique can be implemented in software (SW) so that when a host device, such as an AP, performs a network scan operation, it will receive the normal scan information but also on top of that an internal reference timestamp generated by the WLAN chipset, such as that of a STA.

In operation, when the WLAN device decides to join to some network, it gives the scan information as part of the scan command with the reference clock information. Using the timestamp (TSF timer) information from the 802.11 frame and internal timer, the WLAN chipset can adjust the station's TSF timer to be in synchronisation with the network that it is planning to join. With an accurate chipset reference clock, this type of synchronization is implemented and after waiting the minimum period (depends on used PHY), the station is ready to start sending data.

In an alternative embodiment, the same joining functionality can also be achieved by having a combined scan and join command, where certain criteria for an accepted station is provided as part of the scan command and whenever the WLAN chipset finds such stations, it automatically joins to the WLAN access point and notifies that to the host processor. The same concept as in the previous implementation example is more or less used in this one but the interface towards the host processor would be different one.

### Nodes, STAs, Points or Terminals

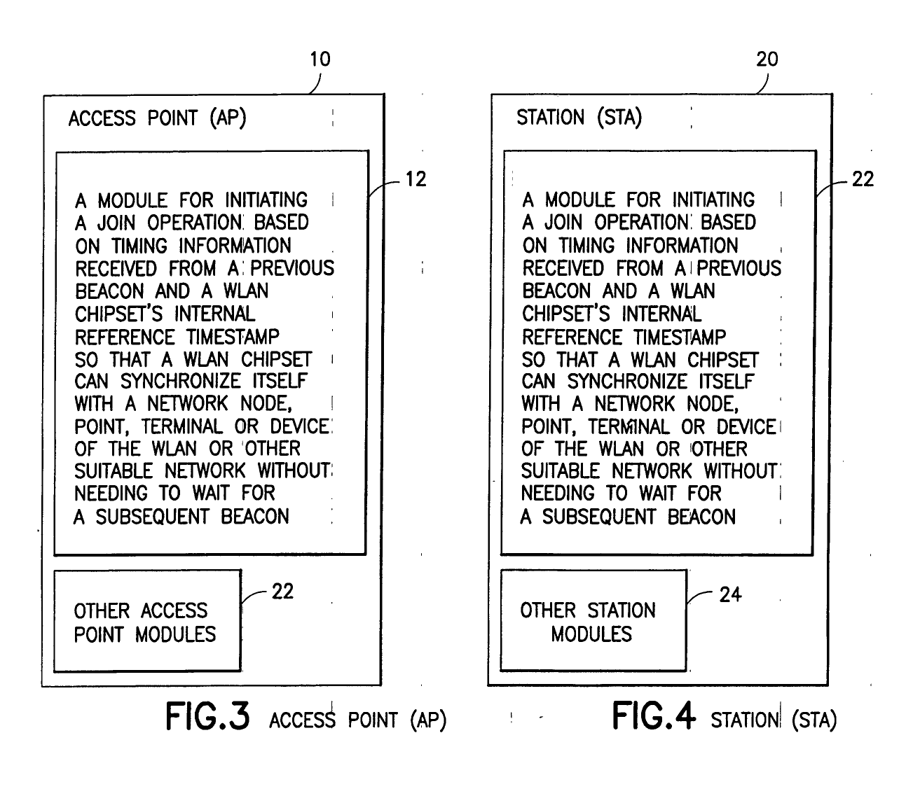

FIGS. 3-4 show two nodes, points, terminals or devices in the WLAN, which take the form of an access point (AP) or other suitable network node, point, terminal or device 10 shown in FIG. 3 and a station (STA) or other suitable network node, point, terminal or device 20 shown in FIG. 4, for operating in a wireless LAN network consistent with that shown in FIGS. 1 and/or 2.

The AP 10 and the STA 20 have corresponding modules 12, 14 and 22, 24 that exchange suitable signalling consistent with that shown and described herein, for initiating the join operation based on the timing information received from the previous beacon and the WLAN chipset's internal reference timestamp so that the WLAN chipset can synchronize itself with the network node, point, terminal or device of the WLAN or other suitable network without needing to wait for the subsequent beacon. The exchange of suitable signalling may also include synchronizing the time synchronization function (TSF) counter of the node, point, terminal or device with the corresponding time synchronization function (TSF) counter of the network node, point, terminal or device in order to implement the join operation consistent with that shown and described herein. The modules 12 and 22 may take the form of, or form part of, a WLAN chipset for performing the aforementioned functionality.

### Implementation of the Functionality of the Modules 12 and 22

The functionality of the AP 10 and STA 20 described above may be implemented in the corresponding modules 12 and 22 shown in FIGS. 3 and 4. By way of example, and consistent with that described herein, the functionality of the modules 12 and 22 may be implemented using hardware, software, firmware, or a combination thereof, although the scope of the invention is not intended to be limited to any particular embodiment thereof. In a typical software implementation, the module 12 and 22 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 12 and 22 being stand alone modules, as shown, or in the combination with other circuitry for implementing another module.

By way of example, FIG. 5 shows a block diagram an exemplary embodiment of the module 22 of the station 20 shown in FIG. 4. (The module 12 of the AP in FIG. 3 would have a similar architecture.) As shown, the module 22 includes the basic logical of a WLAN chipset, which comprises three basic logical components, including the RF, the baseband and the MAC processor. The MAC component includes some kind of processor (typically ARM processor), a real-time clock (RTC), timers, hardware (HW) accelerators and some other interfaces towards outside world. Either the real-time clock (RTC) or timer functionality may be used for generating the timestamps at the chipset side, which would then be passed to the host processor. Having the timestamps from the network side and from the WLAN chipset would allow synchronization towards the network without receiving a additional frames from the network in join process according to embodiments of the present invention.

The scope of the invention is not intended to be limited to where the functionality of the present invention is performed in the node, point, terminal or device. For example, by way of example, the functionality of the present invention is shown and described as being performed in the modules 12, 22, and shown and described in more detail in relation to FIG. 5. However, embodiments of the invention are envisioned, and the scope of the invention is intended to include, the system-on-chip architecture of the node, point, terminal or device having WLAN components being integrated into the same chip, which could provide greater integration e.g. timers from the host-processor might be used for generating time-stamps for the synchronization. However, it makes more sense to do that as the timers in WLAN chipset part of the system are closer to the air-interface and should anyway have higher resolution.

The other modules 14 and 24 in the AP 10 and STA 20 may include corresponding host processor modules with corresponding TSF-counters having functionality as it pertains to the present invention consistent with that described above. The other modules 14 and 24 in the AP 10 and STA 20 may also include other modules, circuits, devices that do not form part of the underlying invention per se. The functionality of the other modules, circuits, devices, including the host processor module, that do not form part of the underlying invention are known in the art and are not described in detail herein. For example, the other modules 24 may include modules that formal part of a typical mobile telephone, node, point, terminal or device, such as a UMTS subscriber identity module (USIM), control processor module, input/output module, display module, keyboard module, and mobile equipment (ME) module, which are known in the art and not described herein.

### The WLAN Chipset

The present invention may also includes a WLAN chipset for a node, point, terminal or device in a wireless local area network (WLAN) or other suitable network, which may take the form of a number of integrated circuits designed to perform one or more related functions, such as that shown in FIG. 5. For example, one chipset may provide the basic functions of a modem while another provides the CPU functions for a computer. Newer chipsets generally include functions provided by two or more older chipsets. In some cases, older chipsets that required two or more physical chips can be replaced with a chipset on one chip. The term “chipset” is also intended to include the core functionality of a motherboard in such a node, point, terminal or device.

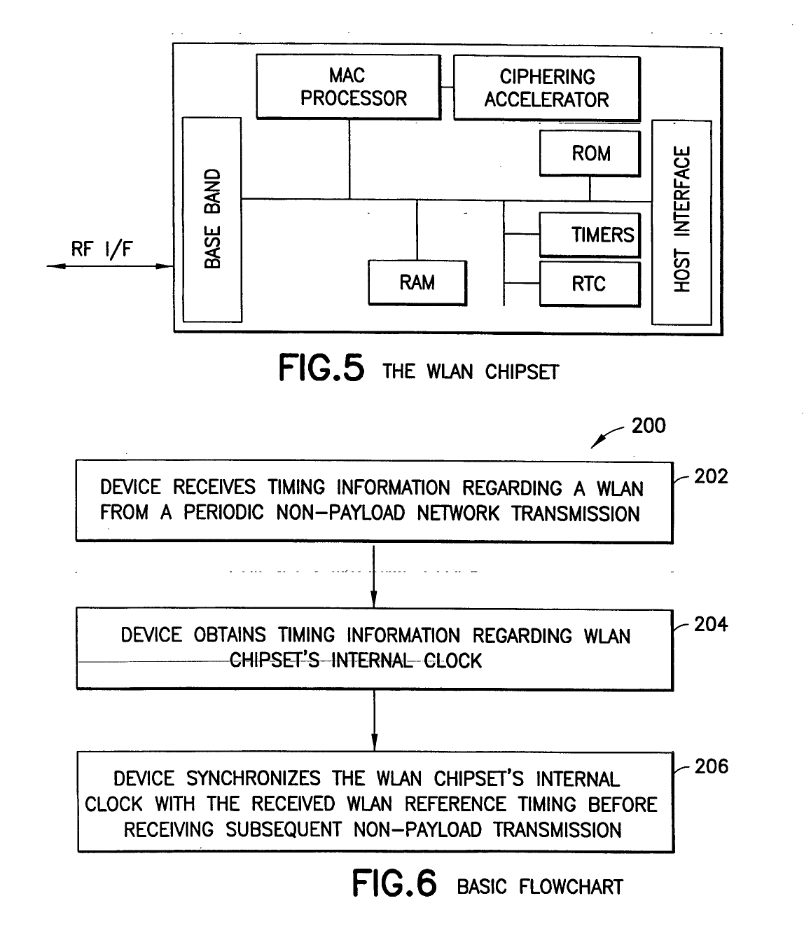

### FIG. 6

FIG. 6 shows basic steps of a method generally indicated as 200 for initiating a join operation with a wireless local area network (WLAN) in a wireless communications device, according to the present invention. The method includes a step 202 for receiving timing information regarding the WLAN from a periodic non-payload network transmission; a step 204 for obtaining timing information regarding the wireless communications device's internal clock; and a step 206 for synchronizing the wireless communications device's internal clock with the WLAN reference timing before receiving subsequent non-payload transmission.

### Advantages/Disadvantages

The present invention also has the following additional advantages/disadvantages:

One advantage of the present invention is that

1) The join process would be significantly faster, which would help especially in various time-sensitive join scenarios, such as, for example network roaming during VoIP call; and

2) The fast-join could in some cases replace the pilot frame scheme (802.11 k) that consumes extra bandwidth from the networks

### The Pilot Frame Scheme

It is important to note that while a pilot frame scheme presently defined in IEEE 802.11 k may reduce the benefits of the WLAN fast-join according to the present invention, it is likely that not all the WLAN access points will support the scheme and even then the pilot frame will be slower than the fast-join technique according to the present invention.

### SCOPE OF THE INVENTION

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

What we claim is:

1. A method for a node, point, terminal or device to join a wireless local area network (WLAN), or other suitable network, characterized in that
a join operation is initiated based on timing information received from a previous beacon and a WLAN chipset's internal reference timestamp so that a WLAN chipset can synchronize itself with a network node, point, terminal or device of the WLAN or other suitable network without needing to wait for a subsequent beacon.

2. A method according to claim 1, wherein the join operation includes synchronizing a time synchronization function (TSF) counter of the node, point, terminal or device with a corresponding time synchronization function (TSF) counter of the network node, point, terminal or device.

3. A method according to claim 1, wherein when the node, point, terminal or device is performing a scan operation and receiving frames, it receives both an official timestamp from a frame and a chipset's reference timestamp for the frame.

4. A method according to claim 1, wherein the join operation is implemented in software so that when a host node, point, terminal or device performs a network scan operation, it will receive normal scan information as well as an internal reference timestamp generated by the WLAN chipset.

5. A method according to claim 4, wherein, when the WLAN node, point, terminal or device joins the WLAN network, it gives the scan information as part of a scan command with reference clock information.

6. A method according to claim 4, wherein using timestamp information from the frame and internal timer, the WLAN chipset can adjust a timer of the node, point, terminal or device to be in synchronisation with the WLAN network that it is planning to join.

7. A method according to claim 1, wherein the join operation is initiated by having a combined scan and join command, where certain criteria for an accepted station is provided as part of the scan command and whenever the WLAN chipset finds such stations, it automatically joins to the WLAN access point and notifies that to the host processor.

8. A method according to claim 1, wherein the node, point, terminal or device includes a station (STA) or other suitable network node or terminal in the WLAN, and the network node, point, terminal or device is an access point (AP) or other suitable network node or terminal.

9. A node, point, terminal or device for joining a wireless local area network (WLAN) or other suitable network, characterized in that
the node, point, terminal or device has a module for initiating a join operation based on timing information received from a previous beacon and a WLAN chipset's internal reference timestamp so that a WLAN chipset can synchronize itself with a network node, point, terminal or device of the network without needing to wait for a subsequent beacon.

10. A node, point, terminal or device according to claim 9, wherein the join operation includes synchronizing a time synchronization function (TSF) counter of the node, point, terminal or device with a corresponding time synchronization function (TSF) counter of the network node, point, terminal or device.

11. A node, point, terminal or device according to claim 9, wherein when the node, point, terminal or device is performing a scan operation and receiving frames, it receives both an official timestamp from a frame and a chipset's reference timestamp for the frame.

12. A node, point, terminal or device according to claim 9, wherein the join operation is implemented in a software module so that when a host or network node, point, terminal or device performs a network scan operation, it will receive normal scan information as well as an internal reference timestamp generated by the WLAN chipset.

13. A node, point, terminal or device according to claim 12, wherein, when the WLAN node, point, terminal or device joins the WLAN network, it gives the scan information as part of a scan command with reference clock information.

14. A node, point, terminal or device according to claim 12, wherein using timestamp information from the frame and internal timer, the WLAN chipset can adjust a timer of the first node, point, terminal or device to be in synchronisation with the WLAN network that it is planning to join.

15. A node, point, terminal or device according to claim 9, wherein the join operation is initiated by having a combined scan and join command, where certain criteria for an accepted station is provided as part of the scan command and whenever the WLAN chipset finds such stations, it automatically joins to the WLAN access point and notifies that to the host processor.

16. A node, point, terminal or device according to claim 9, wherein the node, point, terminal or device includes a station (STA) or other suitable network node or terminal in the WLAN, and the network node, point, terminal or device is an access point (AP) or other suitable network node or terminal.

17. A network node, point, terminal or device for joining with a node, point, terminal or device in a wireless local area network (WLAN) or other suitable network, characterized in that
the network node, point, terminal or device has a module for initiating a join operation based on timing information received from a previous beacon and a WLAN chipset's internal reference timestamp so that a WLAN chipset can synchronize itself with the network node, point, terminal or device of the network without needing to wait for a subsequent beacon.

18. A network node, point, terminal or device according to claim 17, wherein the join operation includes synchronizing a time synchronization function (TSF) counter of the node, point, terminal or device with a corresponding time synchronization function (TSF) counter of the network node, point, terminal or device.

19. A network node, point, terminal or device according to claim 17, wherein the network node, point, terminal or device is an access point (AP) or other suitable network node or terminal, and a node, point, terminal or device seeking to join includes a station (STA) or other suitable network node or terminal in the WLAN.

20. A WLAN chipset for a node, point, terminal or device in a wireless local area network (WLAN) or other suitable network, characterized in that
a join operation between two nodes, points, terminals or devices in the wireless local area network (WLAN) or other suitable network is based on timing information received from a previous beacon and a WLAN chipset's internal reference timestamp so that the WLAN chipset can synchronize itself with a network node, point, terminal or device of the network without needing to wait for a subsequent beacon.

21. A WLAN chipset according to claim 20, wherein the join operation includes synchronizing a time synchronization function (TSF) counter of the node, point, terminal or device with a corresponding time synchronization function (TSF) counter of the network node, point, terminal or device.

22. A computer program product with a program code, which program code is stored on a machine readable carrier, for carrying out the steps of a method comprising one or more steps for initiating a join operation based on timing information received from a previous beacon and a WLAN chipset's internal reference timestamp so that a WLAN chipset can synchronize itself with the network node, point, terminal or device of the network without needing to wait for a subsequent beacon, when the computer program is run in a module of either a first node, point, terminal or device, such as an Access Point (AP), a second node, point, terminal or device, such as a station (STA), or some combination thereof.

23. A method according to claim 1, wherein the method further comprises implementing the step of the method via a computer program running in a processor, controller or other suitable module in one or more network nodes, points, terminals or elements in the wireless LAN network.

24. A method for initiating join operation with a wireless local area network (WLAN) in a wireless communications device, comprising:
receiving timing information regarding the WLAN from a periodic non-payload network transmission;
obtaining timing information regarding the wireless communications device's internal clock; and
synchronizing the wireless communications device's internal clock with the WLAN reference timing before receiving subsequent non-payload transmission.

25. A method according to claim 24, wherein the periodic non-payload network transmission comprises a WLAN beacon message.

26. A wireless communications device, comprising:
a wireless communications interface for receiving timing information regarding a wireless local area communications network (WLAN) from a periodic non-payload network transmission;
a timer module managing an internal clock: and
a controller coupled with the wireless communications interface and the timer module configured to synchronize the internal clock with the WLAN reference timing before receiving subsequent non-payload transmission.

27. A device according to claim 26, wherein the periodic non-payload network transmission comprises a WLAN beacon message.

28. A WLAN chipset for a node, point, terminal or device in a wireless local area network (WLAN) or other suitable network, comprising;
an RF transceiver for receiving timing information regarding a wireless local area communications network (WLAN) from a periodic non-payload network transmission;
a timer module managing an internal clock: and
a controller coupled with the wireless communications interface and the timer module configured to synchronize the internal clock with the WLAN reference timing before receiving subsequent non-payload transmission.
